(19) United States
(12) Patent Application Publication
(10) Pub. No.: US 2026/0286770 A1
(43) Pub. Date: Sep. 24, 2026

(54) FABRIC CLIP FOR ROLLER SHADE ASSEMBLY

(71) Applicant: SMART SHADE INNOVATIONS INC., Chatham (CA)

(72) Inventors: Anthony Bhatt, Glencoe (CA); Larry MEYERINK, Dresden (CA); Dean GRUBB, Appin (CA); Alex MEYERINK, Chatham (CA)

(73) Assignee: SMART SHADE INNOVATIONS INC., Chatham (CA)

(21) Appl. No.: 19/475,565

(22) PCT Filed: Sep. 29, 2023
(86) PCT No.: PCT/CA2023/051299

§ 371 Date: Oct. 15, 2025

Related U.S. Application Data
(60) Provisional application No. 63/460,199, filed on Apr. 18, 2023.

(51) Int. Cl. E06B 9/42

(52) U.S. Cl. CPC E06B 9/42

(57) ABSTRACT

A clip for sheet material with a free end, having opposing first and second clip sections, each having a top, bottom, outside, and an inside facing the other clip section and a locking flange extending from the inside between the top and bottom. The locking flanges are shaped to engage with each other in a plurality of positions. The first clip section has a gripping flange adjacent to the top of the first clip section and the second clip section has a gripping recess adjacent to the top of the second clip section shaped complementary to the gripping flange to fit together to form a gripping portion of the clip for retaining the free end of the sheet material therein.

### FIELD OF THE INVENTION

The present invention relates to window coverings, in particular, to a fabric clip for a roller shade assembly or similar fabric window coverings or fixed panels.

### BACKGROUND

Roller shades are typically operated by chain drive assemblies, motors, or other similar mechanisms, to roll and unroll a sheet of fabric that is used for room darkening or privacy control. Roller shades may also be cordless or use specialized drive assemblies, such as the Ultraglide™ drive assembly. In these applications, it is important to provide a weight at the bottom edge of the roller shade fabric to facilitate the rolling and unrolling and ensure the roller shade fabric is held in place over the window opening. Common examples of such weights include aluminium, wooden, or plastic bottom bar rods. Generally, the bottom edge of the fabric is attached to the weight by straps, adhesives, or fasteners, such as staples and then normally slid into a bottom bar from the side. For aesthetic purposes, the fabric may be exposed, fully wrapped, or partially wrapped, around the weight (or bottom bar) to provide a more consistent appearance to the roller shade.

Attaching the bottom edge of the fabric to the weight in this way is a labour intensive process, requiring sliding the fabric over a fabric retaining strip from the side, and can result in an uneven or wrinkled appearance of the fabric, or damage to the fabric, along the bottom edge. Accordingly, there is a need to improve the weights used at the bottom edges of roller shades.

### SUMMARY OF THE INVENTION

A clip for sheet material with a free end, according to the present invention, has opposing first and second clip sections, each having a top, bottom, outside, and an inside facing the other clip section and a locking flange extending from the inside between the top and bottom. The locking flanges are shaped to engage with each other in a plurality of positions. The first clip section has a gripping flange adjacent to the top of the first clip section and the second clip section has a gripping recess adjacent to the top of the second clip section shaped complementary to the gripping flange to fit together to form a gripping portion of the clip for retaining the free end of the sheet material therein.

In another embodiment, at least one of the locking flanges has a plurality of ridges or grooves shaped complementary to a ridge or groove on the other locking flange.

In another embodiment, the plurality of ridges or grooves comprises a first and second ridge or groove, the ridge or groove on the other locking flange comprises a third ridge or groove, and the second ridge or groove is located closer to the inside of the respective clip section than the first ridge or groove.

In another embodiment, the plurality of positions comprises a first position and a second position, the third ridge or groove is engaged with the first ridge or groove in the first position, and the third ridge or groove is engaged with the second ridge or groove in the second position.

In another embodiment, the second clip section has one or more flexible regions to permit a first portion of the second clip section on one side of the one or more flexible regions to move relative to a second portion of the second clip section on the other side of the one or more flexible regions, and the locking flange is located within the first portion and the gripping recess is located within the second portion.

In another embodiment, an intermediate flange on the first clip section is configured to engaged with the gripping recess of the second clip section and the bottom of the first clip section is configured to engage with the locking flange of the second clip section to permit the first and second clip sections to fit together in a pre-assembly position with their respective tops and bottoms offset from one another.

### BRIEF DESCRIPTION OF THE DRAWINGS

In order that the invention may be more clearly understood, embodiments thereof will now be described in detail by way of example, with reference to the accompanying drawings, in which:

FIG. 1 is a perspective view of the clip, according to the present invention, attached to the bottom end of sheet material of a roller shade.

FIG. 2 is a side sectional view of the clip, as shown in FIG. 1.

FIG. 3 is a side sectional view of the clip, shown partially wrapped in the sheet material.

FIG. 4 is an exploded view of the clip.

FIG. 5 is a side sectional view of the clip, shown in the shipping position.

FIG. 6A is a side sectional view of the clip, shown in a pre-lock position.

FIG. 6B is a side sectional view of the clip, shown in pre-locking position.

FIG. 7 is a side sectional view of the clip, shown in the pre-locking position and illustrating the method of performing a partial fabric wrap of the clip.

FIG. 8 is a side sectional view of the clip, shown fully wrapped in the sheet material.

FIG. 9A is a side sectional view of an alternative clip, shown in a fully exposed assembly configuration.

FIG. 9B is a side sectional view of the clip shown in FIG. 9A, in a partially wrapped assembly configuration.

FIG. 9C is a side sectional view of the clip shown in FIG. 9A, in a fully wrapped assembly configuration.

FIG. 10 is a side sectional view of another alternative clip, shown in a fully exposed assembly configuration.

FIG. 11 is a side sectional view of the clip shown in FIG. 10, in a fully wrapped assembly configuration.

FIG. 12 is a side sectional view of another alternative clip, shown in a fully exposed assembly configuration.

FIG. 13 is a side sectional view of the clip shown in FIG. 12, in a fully wrapped assembly configuration.

### DESCRIPTION OF THE INVENTION

A fabric clip for sheet material with a free end, according to the present invention, may be used with various types of roller shade assemblies, including common chain drive assemblies, motorized roller shade assemblies, or more specialized drive assemblies or even with Roman shades or stationary fabric panels. Various applications for the fabric clip of the present invention exist where sheet material with a free end requires weighting or fixing in place. In all of these applications, a clip is required to attach to one or more free ends of the fabric to provide a weight or to hold the fabric in place. The clip allows the assembly of the bottom bar of the roller shade assembly without the need for sliding any components from the side, along the free end of the fabric, which reduces the complexity of the assembly process and the potential for damaging the fabric.

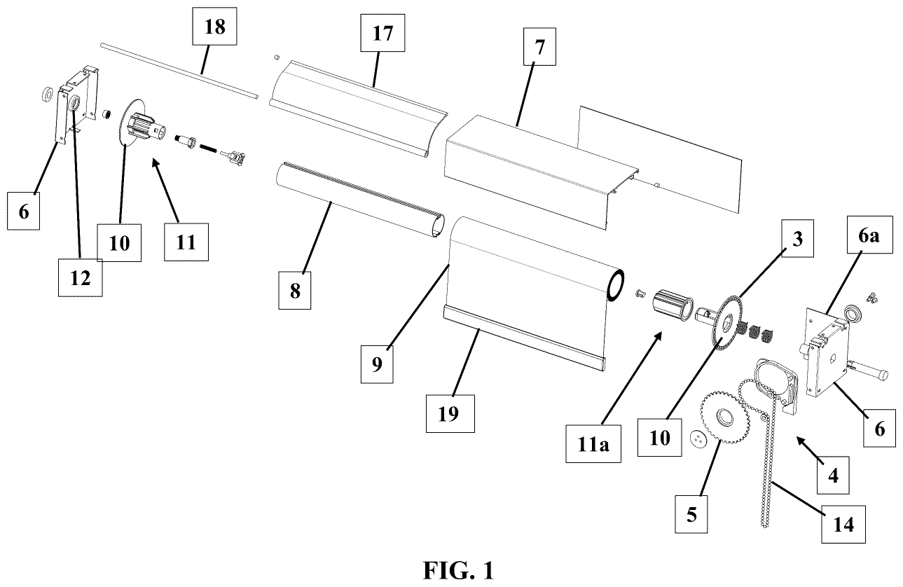

As shown in FIG. 1, a roller shade assembly (not shown) has a length of sheet material, or fabric 1, that hangs therefrom. The roller shade assembly has a roller, which is rotatably mounted to a frame to wind and unwind the fabric 1 on a roller tube. A weight is provided by way of a clip 3 attached to the lower end, or free end 1a, of the fabric 1.

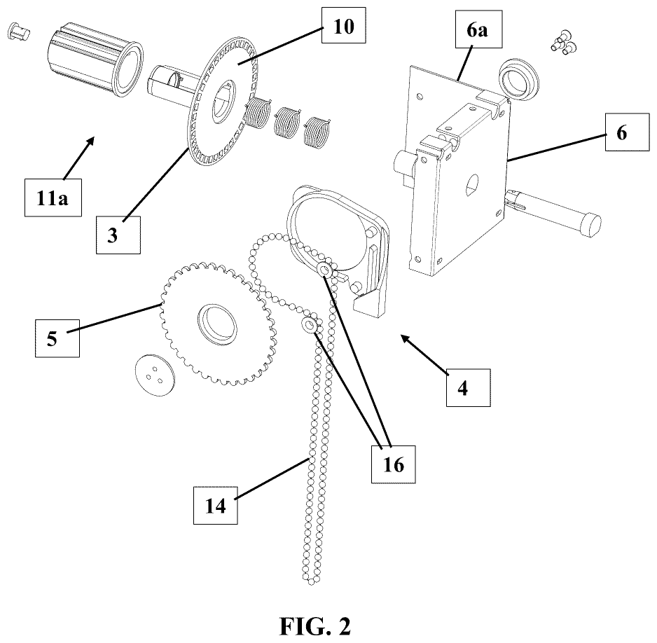

As shown in FIGS. 2, 3, and 5-7, the clip 3 has a grip portion 4 that attaches to and retains the free end 1a of the fabric 1 therein. The clip 3 has two opposing sections that lock together to clamp or grip the free end la of the fabric 1 and retain it in the grip portion 4. Preferably, the opposing sections of the clip 3 are made of a flexible material and lock together by way of a snap-fit. Alternatively, the opposing sections of the clip 3 may lock together by way of a cam-lock, wedge-lock, or other suitable locking mechanism.

As shown in FIG. 2, each of the two opposing sections 3a and 3b have a top 5, a bottom 6, an outside 7 facing away from the other opposing section, and an inside 8 facing towards the other opposing section. A first clip section 3a has a locking flange 9a extending from the inside 8 between the top 5 and the bottom 6. A second clip section 3b has a locking flange 9b extending from the inside 8 shaped to engage with the locking flange 9a of the first clip section 3a. Preferably, the outside 7 of both opposing sections 3a and 3b are tapered (or have mitered corners) at the top 5 and bottom 6 to prevent catching on obstacles in or around the window. The clip 3 may also have a symmetrical outside shape to permit use in any orientation. Optionally, in applications with light-blocking materials on either side of the window opening with a narrow channel into which the sides of the fabric 1 fit and travel, one of the opposing clip sections 3a or 3b may be cut shorter, so that the other clip section 3a or 3b extends into and travels up and down in the narrow channel along the sides of the window opening.

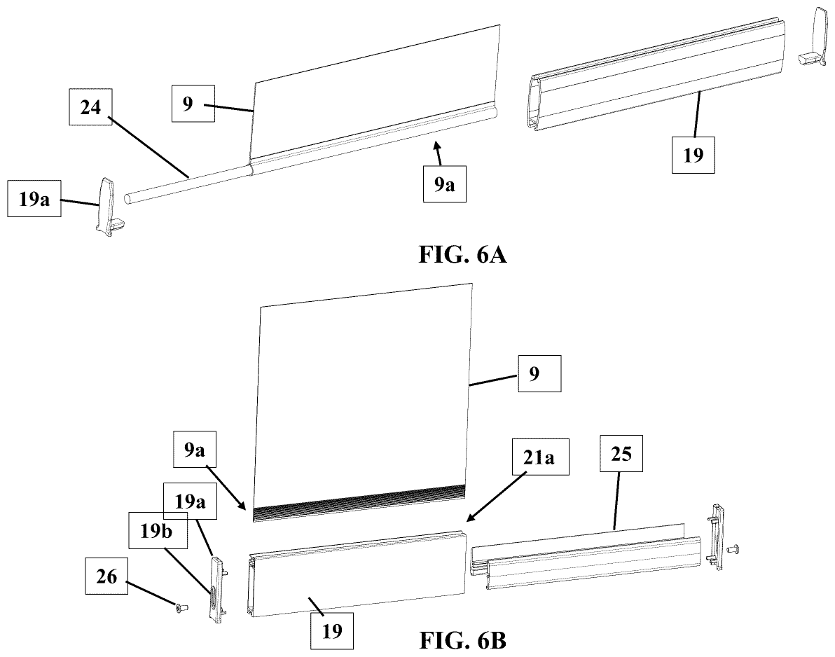

Preferably, the grip portion 4 is a pinch point defined by a gripping flange 10a on one of the opposing sections of the clip 3 that is pressed into a gripping recess 10b on the other opposing section of the clip 3 to facilitate gripping the free end 1a of the fabric 1. As shown in FIGS. 6A and 6B, the gripping flange 10a is configured to form a shoulder and the fabric 1 is wrapped around or folded over the gripping flange 10a on the first clip section 3a before the gripping flange 10a, with the fabric 1 wrapped around it, is pressed into the gripping recess 10b on the second clip section 3b. Thereafter, the snap-fitting of the two locking flanges 9a and 9b presses the gripping flange 10a into the gripping recess 10b. The fabric 1 is thereby frictionally retained in the pinch point. Optionally, one or both opposing sections of the clip 3 may have an adhesive, such as two-way tape, applied to the grip portion 4 to assist in gripping the fabric 1. Preferably, a strip of two-way tape is applied to a flat portion of the gripping flange 10a below the fabric 1, which works together with the folding of the fabric 1 over the shoulder of the gripping flange 10a to provide a secure grip on the free end la of the fabric 1.

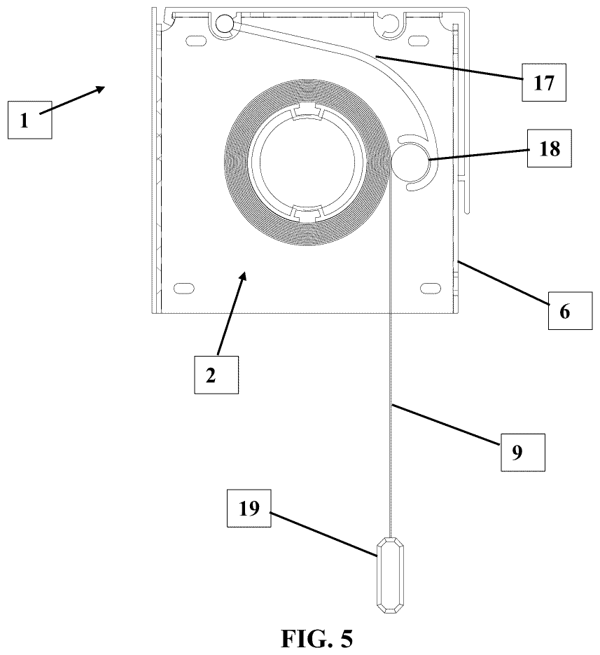

As shown in FIGS. 5 and 6A, the gripping recess 10b on the second clip section 3b may be biased away from the inside 8 of the second clip section 3b, toward the first clip section 3a. One or more flexible regions 23 may be provided on the second clip section 3b to permit the gripping recess 10b to flex outwardly, to permit the snap-fitting of the locking flanges 9a and 9b. Preferably, a flexible region 23 is provided by reducing the thickness of the second clip section 3b where the gripping recess 10b extends downwardly from the top 5 of the second clip section 3b. Alternatively, the flexible regions 23 may be provided by forming these regions of the second clip section 3b of a more flexible material, providing hinge joints, or any other suitable means of providing a flex joint. These flexible regions 23 permit the clip 3 to adjust the engagement of the gripping flange 10a and the gripping recess 10b to accommodate different fabrics 1 of various thicknesses and still provide a secure grip on the free end 1a of the fabric 1. By providing at least two flexible regions 23, the gripping recess 10b is permitted to move relative to the gripping flange 10a, without changing the relative angle of engagement of the gripping flange 10a and gripping recess 10b. This prevents a gap from forming at the top 5 of the clip 3 with thicker fabric 1. The adjustable regions 23 also permit the end of the second clip section 3b that forms the gripping recess 10b to be used as a folding arm to direct the fabric over the shoulder of the gripping flange 10a, as shown in FIG. 6, before the clip 3 is snapped shut, as shown in FIG. 2.

Additionally, because of the capacity of the clip 3 to accommodate different thicknesses of fabric 1 by way of the flexible regions 23, both the first and second clip sections 3a and 3b may be in contact with the fabric 1 substantially along the entire length of the top 5 of the clip 3. Traditional clips (or bottom bars) have a gap between one or both sides of the clip and the fabric, due to the fact that traditional clips are assembled by sliding the two opposing sides of the clip together longitudinally and require a gap to avoid stretching or damaging the fabric during assembly. Unlike traditional clips or bottom bars, the clip 3 compresses the fabric 1 between the opposing clip sections 3a and 3b and holds the fabric 1 flat along the top 5 of the clip 1.

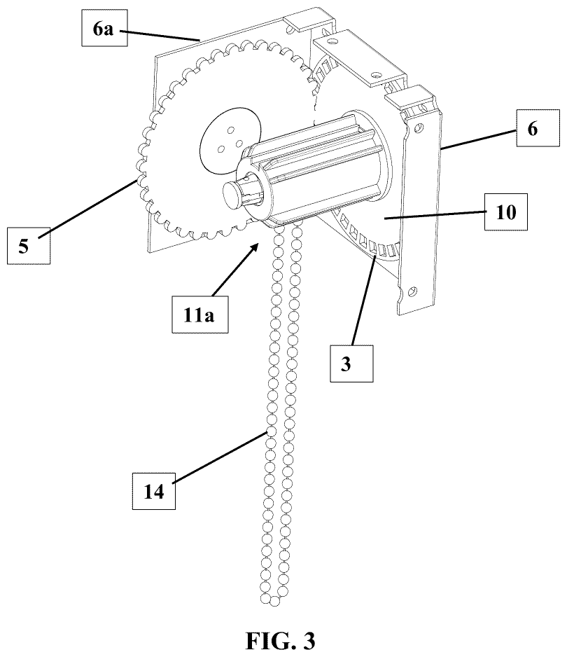

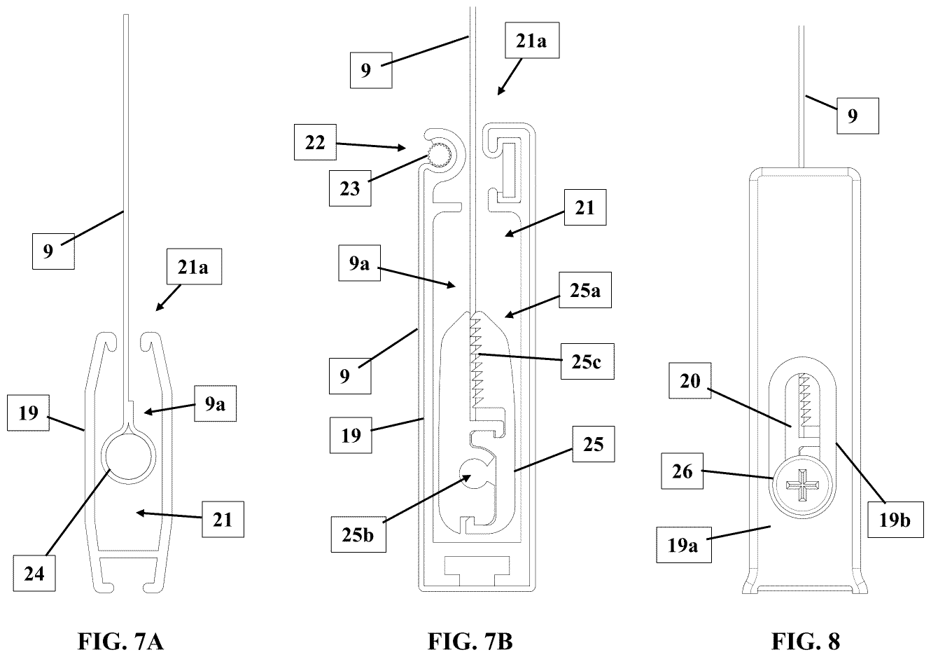

As shown in FIGS. 3, 7, and 8, the clip 3 may be fully wrapped or partially wrapped in the fabric 1 (or exposed, with no fabric 1 wrapped around the clip 3). The clip 3 may have a groove 11 formed along the bottom 6 in which a loop of the fabric 1 is retained by a rod 12. Preferably, the groove 11 is formed by both of the opposing first and second clip sections 3a and 3b when the two are snap-fitted together. Alternatively, the groove 11 may be formed in either first or second section 3a or 3b of the clip 3. The fabric 1 passes from the grip portion 4 around the clip 3 and a loop of the fabric 1 is retained in the groove 11 by a rod 12 that may be snap-fitted into the groove 11. If it is desired to fully wrap the clip 3 in the fabric 1, then beginning with the clip 3 in the intermediate position and partially wrapped with fabric 1, as shown in FIG. 7, the fabric 1 may be wrapped around the top 5 and back down into the groove 11 at the bottom 6 of the clip 3. Another loop of fabric 1 may be pressed into the groove 11 by a rod 12 and the clip 3 snapped shut with the fabric 1 covering the outside 7 of both the opposing clip sections 3a and 3b, as shown in FIG. 8. This creates a consistent appearance along the full length of the blind, including the clip 3 along the free end 1a of the fabric 1. Where the colour of the front and back of the fabric 1 of the blind is different, the opposing clip sections 3a and 3b may be different colours to match or contrast, depending on the desired aesthetic on either side of the blind. Different materials may also be used for each of the opposing clip sections 3a and 3b.

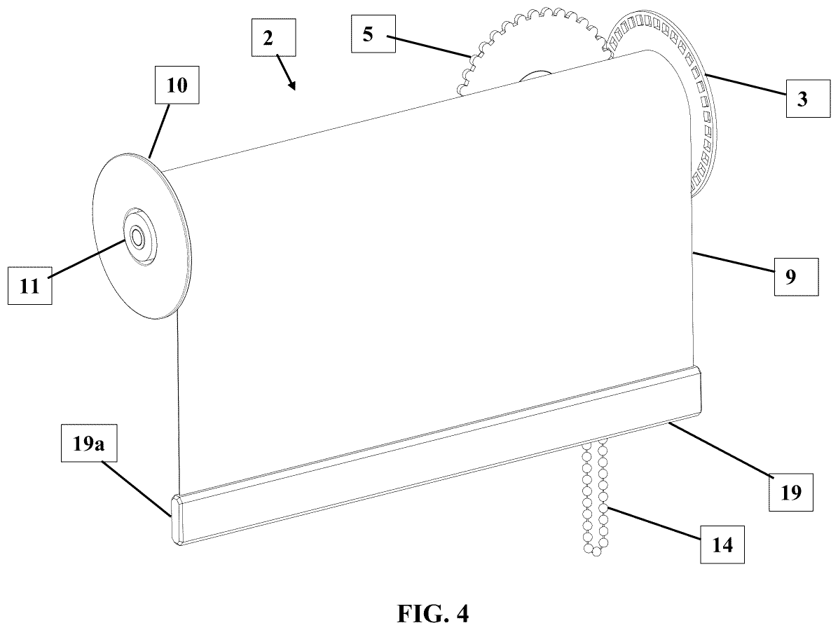

As shown in FIGS. 1 and 4, the clip 3 may have caps 13 at either end to prevent the opposing first and second clip sections 3a and 3b from coming apart. The clip 3 may also have one or more gaps 14 formed between the opposing clip sections 3a and 3b, as shown in FIG. 2. The gaps 14 may variously receive set screws to apply additional pressure to the fabric 1 in the grip portion 4, or weights to increase the downward force on the fabric 1, which may be desirable for applications with heavier fabrics. Alternatively or in addition, the rod 12 may be made of a heavy material, such as steel or other metal, to provide additional desired weight. Additionally, the set screws or a post or similar feature extending from the end cap 13 may fit into the gap 14 and apply pressure to the locking flanges 9a and 9b to hold them together.

Preferably, the locking flanges 9a and 9b have complimentary ridges and grooves so as to snap-fit and lock the opposing first and second clip sections 3a and 3b together. As shown in FIGS. 6A and 6B, the locking flange 9a on the first clip section 3a has a ridge 15, while the locking flange 9b of the second clip section 3b has a first groove 17 and a second groove 18, which is located closer to the inside 8 of the second clip section 3b than the first groove 17. This configuration permits the opposing clip sections 3a and 3b to be pressed together and snapped into an intermediate position before being snapped into an installation position. Optionally, the locking flange 9b may have a third groove 17a, which is located farther from the inside 8 of the second clip section 3b than the first groove 17. The third groove 17a is preferably located adjacent the distal end of the locking flange 9b to provide a loose snap fit connection with the locking flange 9a to releasably hold the clip 3 in a pre-lock position, as shown in FIG. 6A. To move the opposing clip sections 3a and 3b into the pre-lock position, the gripping flange 10a is pressed into the gripping recess 10b and the first and second clip sections 3a and 3b are pressed together until the ridge 15 snaps into the third groove 17a. Where no third groove 17a is provided, the first and second clip sections 3a and 3b are pressed together until the ridge 15 snaps into the first groove 17. From the pre-lock position, to move the opposing clip sections 3a and 3b into the intermediate position, as shown in FIG. 6B, the first and second clip sections 3a and 3b are pressed together until the ridge 15 snaps into the first groove 17. From the intermediate position, to move the opposing clip sections 3a and 3b into the installation position, the first and second clip sections 3a and 3b are pressed together until the ridge 15 snaps into the second groove 18, as shown in FIG. 2.

Optionally, the clip 3 may be partially wrapped in fabric 1 and a rod 12 may be inserted into the groove 11 to retain a loop of the fabric 1 therein, as shown in FIG. 7, before the opposing clip sections 3a and 3b are moved from the intermediate position to the installation position. Because the clip 3 remains partially open in the intermediate position (as shown in FIGS. 6 and 7), the rod 12 may be inserted into the groove 11 through the gap at the bottom 6 of the clip 3, rather than being inserted into the groove 11 longitudinally, after the clip 3 is fully snapped shut (as with traditional fabric wrapped clips). This avoids stretching, wrinkling, or damage to the fabric 1 that can occur when the rod 12 is inserted longitudinally, from the open side of the clip 3.

The clip 3 is configured to fit together in a plurality of different positions, including the intermediate position, as shown in FIGS. 6 and 7, and the installation position, as shown in FIGS. 2 and 3. Preferably, the opposing clip sections 3a and 3b are also configured to fit together releasably in a pre-assembly shipping or manufacturing position, as shown in FIG. 5. In this embodiment, the first clip section 3a also has one or more intermediate flanges 19 extending from the inside 8 of the first clip section 3a between the gripping flange 10a and the locking flange 9a. The intermediate flanges 19 are configured to engage with a second clip section 3b adjacent the top 5 of the second clip section 3b. As shown in FIG. 5, the first clip section 3a has two intermediate flanges 19 that engage with the second clip section 3b adjacent the gripping recess 10b. The locking flange 9b of the second clip section 3b also has a third groove 21, which is configured to engage with a ridge 22 at the bottom 6 of the first clip section 3a. When the two opposing clip sections 3a and 3b are fitted together in the shipping position, as shown in FIG. 5, the respective top 5 and bottom 6 of the first and second clip sections 3a and 3b are offset from one another. Preferably, the second clip section 3b is offset with its bottom 6 extending beyond the bottom 6 of the first clip section 3a. In the shipping position, the first and second clip sections 3a and 3b are releasably retained together for handling, transport, and storage, but may be separated for installation. The clip 3 may also be cut to length while the opposing clip sections 3a and 3b are in the shipping position.

Optionally, one of the intermediate flanges 19 may be configured to act as a fabric stop to assist in aligning the fabric 1 with the clip 3, during assembly. As shown in FIG. 5, an intermediate flange 19 may be positioned a short distance from the gripping flange 10a. Preferably, the gripping flange 10a has a flat surface that is generally parallel to the side of the first clip section 3a and the intermediate flange 19 adjacent to the gripping flange 10a is oriented generally perpendicular to the flat surface of the gripping flange 10a. The fabric 1 may be positioned against the flat surface of the gripping flange 10a and slid over the first clip section 3a until the free end la of the fabric 1 comes into contact with the intermediate flange 19. Preferably, the distance between the shoulder of the gripping flange 10a and the intermediate flange 19 is less than the distance between the shoulder of the gripping flange 10a and the inside 7 of the first clip section 3a, to permit the optimal length of fabric 1 to extend past the shoulder of the gripping flange 10a for folding over the shoulder during assembly. In this position, an appropriate length of fabric 1 is positioned over the gripping flange 10a to permit the fabric to be folded over the shoulder or edge of the gripping flange 10a and pinched and held in the gripping recess 10b when the first and second clip sections 3a and 3b are fully assembled.

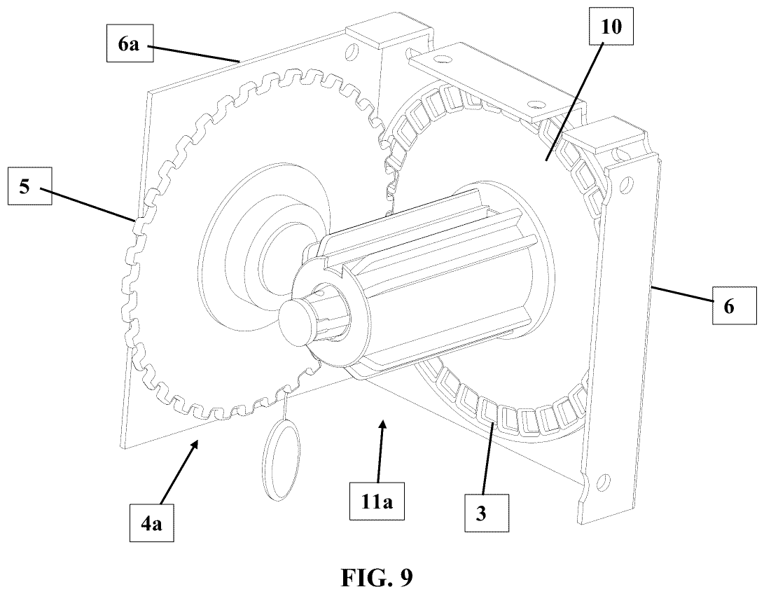

Alternatively, rather than using a rod 12 to retain a loop of fabric 1 within a groove 11 at the bottom 6 of the clip 3, a second gripping flange 10a and second gripping recess 10b may be provided at the bottom 6 of the clip 3, as shown in FIGS. 9A-9C. The second gripping flange 10a and second gripping recess 10b function similarly to the gripping flange 10a and gripping recess 10b at the top 5 of the clip 3, as described above. In order to facilitate assembly and retention of the fabric 1 in the bottom 6 of the clip 3, one of the opposing clip sections 3a or 3b may have flexible section 23 at or adjacent to the bottom 6. Preferably, the flexible sections 23 at the bottom 6 are on the same opposing clip section 3a or 3b as the flexible sections 23 at the top 5. The second gripping flange 10a and second gripping recess 10b may be on the same or opposite clip sections as the gripping flange 10a and gripping recess 10b at the top 5 of the clip 3. Preferably, each opposing clip section 3a and 3b has a gripping flange 10a at one and a gripping recess 10b at the other.

In assembly, the free end 1a of the fabric 1 may be retained in the second gripping flange 10a and second gripping recess 10b, in an exposed assembly configuration, as shown in FIG. 9A. For a partially wrapped assembly configuration, the free end la of the fabric 1 may be retained in the gripping flange 10a and gripping recess 10b at the top 5 of the clip, as described above, and the fabric 1 wrapped around one side of the clip 3 and a loop of fabric pinched or otherwise retained in the second gripping flange 10a and second gripping recess 10b at the bottom 6 of the clip 3, as shown in FIG. 9B. A fully wrapped assembly configuration is shown in FIG. 9C, with the fabric 1 wrapped around the entire clip 3 and both the free end 1a and a loop of the fabric 1 retained in the second gripping flange 10a and second gripping recess 10b at the bottom 6 of the clip 3.

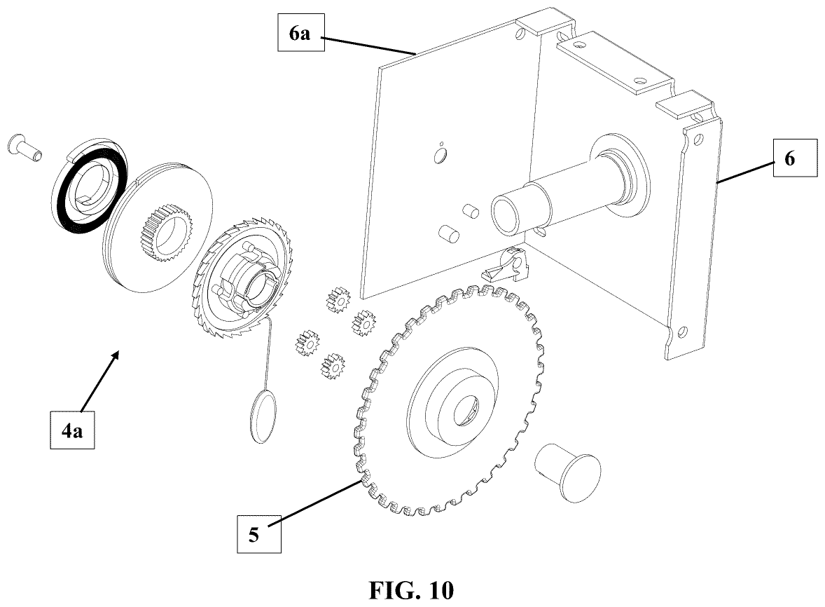

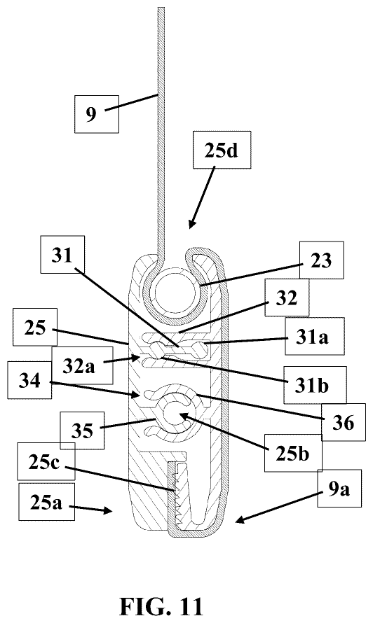

The clip 3 has been described as having a first clip section 3a and a second clip section 3b, which move relative to each other to facilitate assembly. As shown in FIGS. 1-9, the opposing clip sections 3a and 3b are formed as two separate pieces and are configured to engage (i.e. by snap fit) with each other. Alternatively, the opposing clip sections 3a and 3b may be two sections of a single, monolithic piece, configured to flex, pivot, or otherwise move relative to each other. As shown in FIGS. 10 and 11, a one-piece clip 3 may have a flex joint 25 at either the top 5 or bottom 6 that connects the opposing clip sections 3a and 3b and permits them to pivot relative to each other about the flex joint 25. This one-piece clip 3 would lack any groove 11 for receiving a rod 12 and loop of fabric 1 to facilitate a fabric wrapped assembly of the clip 3, since only one of the top 5 or bottom 6 of the clip 3 would be available to receive and grip the free end la of the fabric 1. However, a fabric wrapped assembly may still be accomplished, as shown in FIG. 11, by gripping both the free end 1a and a loop of the fabric 1 between the gripping flange 10a and the gripping recess 10b. In a one-piece clip 3, the capacity to accommodate various thicknesses of fabric 1 between the gripping flange 10a and gripping recess 10b may also permit the gripping of three layers of fabric 1, as shown in FIG. 11, to permit a fabric wrapped assembly of a one-piece clip 3.

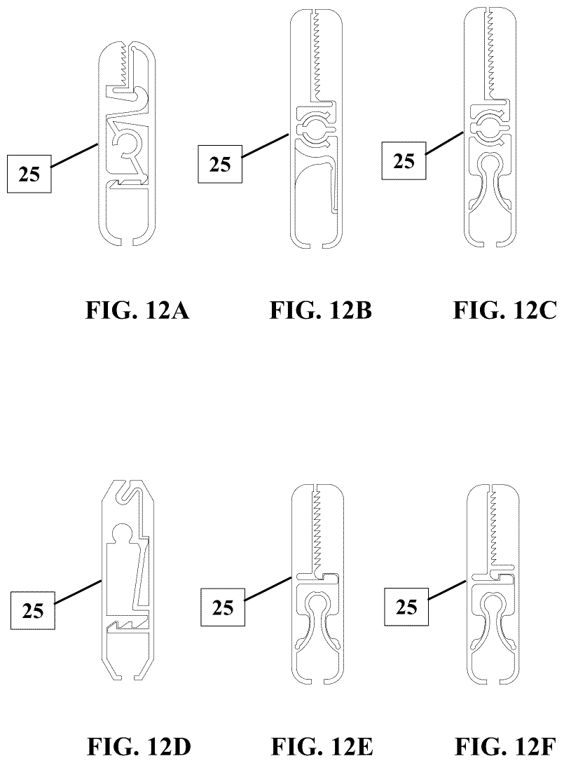

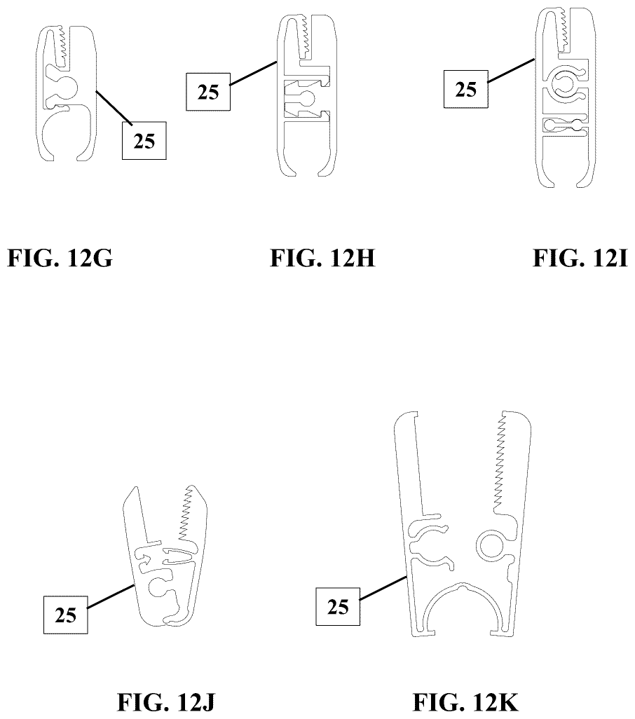

The opposing clip sections 3a and 3b of the clip 3 may be two separate pieces, as shown in FIGS. 1-9, or a single piece, as shown in FIGS. 10 and 11, but the opposing clip sections 3a and 3b may also be two pieces that are connected at a hinge 26 or other joint to permit relative movement between the opposing clip sections 3a and 3b. The hinge 26 may be any suitable type of hinged connection, such as a hinge joint, a piano hinge, or a pin and barrel hinge. As shown in FIGS. 12 and 13, the hinge 26 is located at the top 5 of the clip 3, but (as with the flex joint 25) may be located at either the top 5 or bottom 6 of the clip 3 and the gripping flange 10a and gripping recess 10b will be located at the opposite end of the clip 3.

The present invention has been described with reference to exemplary embodiments, however, it will be understood by those skilled in the art that various changes may be made and equivalents may be substituted for elements thereof without departing from the scope of the invention as set out in the following claims. Therefore, it is intended that the invention not be limited to the particular embodiments disclosed herein.

What is claimed is:

1. A clip for sheet material with a free end, the clip comprising:
opposing first and second clip sections, each having a top, bottom, outside, and an inside facing the other clip section and a locking flange extending from the inside between the top and bottom;
wherein the locking flanges are shaped to engage with each other in a plurality of positions; and
wherein the first clip section has a gripping flange adjacent to the top of the first clip section and the second clip section has a gripping recess adjacent to the top of the second clip section shaped complementary to the gripping flange to fit together to form a gripping portion of the clip.

2. The clip of claim 1, wherein at least one of the locking flanges has a plurality of ridges or grooves shaped complementary to a ridge or groove on the other locking flange.

3. The clip of claim 2, wherein the plurality of ridges or grooves comprises a first and second ridge or groove, wherein the ridge or groove on the other locking flange comprises a third ridge or groove, and wherein the second ridge or groove is located closer to the inside of the respective clip section than the first ridge or groove.

4. The clip of claim 3, wherein the plurality of positions comprises a first position and a second position, wherein the third ridge or groove is engaged with the first ridge or groove in the first position, and wherein the third ridge or groove is engaged with the second ridge or groove in the second position.

5. The clip of claim 4, wherein the second clip section has one or more flexible regions to permit a first portion of the second clip section on one side of the one or more flexible regions to move relative to a second portion of the second clip section on the other side of the one or more flexible regions, and wherein the locking flange is located within the first portion and the gripping recess is located within the second portion.

6. The clip of claim 5, wherein the one or more flexible regions are configured to bias the gripping recess away from the inside of the second clip section.

7. The clip of claim 5, wherein the one or more flexible regions comprises at least two flexible regions.

8. The clip of claim 7, wherein the at least two flexible regions permit the gripping recess to move relative to the gripping flange without changing the relative angle of the gripping flange and gripping recess.

9. The clip of claim 5, wherein the one or more flexible regions permit the second portion of the second clip section to pivot relative to the first clip section when the gripping recess is engaged with the gripping flange.

10. The clip of claim 9, comprising a groove formed at the bottom of the clip between the first and second clip sections for receiving a loop of the sheet material and a rod to retain the loop of sheet material within the groove.

11. The clip of claim 10, wherein the groove has an opening at the bottom of the clip and wherein the size of the opening is larger in the first position than the second position.

12. The clip of claim 11, wherein the size of the opening is larger than the rod in the first position and smaller than the rod in the second position.

13. The clip of claim 2, wherein the gripping flange is shaped to define a shoulder, which cooperates with the complementary-shaped gripping recess to form a pinch point for the sheet material in the gripping portion of the clip.

14. The clip of claim 2, wherein at least one of the first or second clip sections comprises an intermediate flange extending from the inside between the top and the locking flange.

15. The clip of claim 14, wherein the intermediate flange is on the first clip section and is configured to engaged with the gripping recess of the second clip section and the bottom of the first clip section is configured to engage with the locking flange of the second clip section to permit the first and second clip sections to fit together in a pre-assembly position with their respective tops and bottoms offset from one another.

16. The clip of claim 15, wherein the intermediate flange is positioned a distance from the gripping flange less than the distance between the gripping flange and the inside of the first clip section, so as to act as a stop for the free end of the sheet material and facilitate alignment of the sheet material for assembly of the clip.

17. The clip of claim 16, wherein the gripping flange has a flat portion and the intermediate flange is oriented generally perpendicular to the flat surface of the gripping flange.

18. The clip of claim 17, wherein the flat surface may receive an adhesive to hold the free end of the sheet material in place during assembly of the clip.

19. The clip of claim 14, wherein the intermediate flange is on the second clip section and is configured to engaged with the gripping flange of the first clip section and the bottom of the second clip section is configured to engage with the locking flange of the first clip section to permit the first and second clip sections to fit together in a pre-assembly position.

20. The clip of claim 2, wherein the opposing first and second clip sections are pivotably connected to each other at their respective bottoms.

21. The clip of claim 20, wherein the opposing first and second clip sections are each part of a single monolithic structure and are pivotably connected by way of a flex joint.

22. The clip of claim 20, wherein the opposing first and second clip sections are pivotably connected by way of a hinge.
